(19) United States
(12) Patent Application Publication
(10) Pub. No.: US 2015/0313404 A1
(43) Pub. Date: Nov. 5, 2015

(54) FILM MADE OF AN ALLOY OF ALUMINUM AND IRON, USE OF SUCH MATERIAL IN COMBINATION WITH AN OSCILLATING MAGNETIC FIELD AND KITCHEN UTENSIL FOR INDUCTION COOKING, COMPRISING SUCH FILM

(71) Applicant: Ennio CORRADO, ARSAGO SEPRIO (VA) (IT)

(72) Inventor: Ennio CORRADO, ARSAGO SEPRIO (VA) (IT)

(21) Appl. No.: 14/700,386

(22) Filed: Apr. 30, 2015

(30) Foreign Application Priority Data
Apr. 30, 2014 (IT) MI2014A000801

(51) Int. Cl. A47J 36/02; C22C 21/00; H05B 6/12

(52) U.S. Cl. CPC A47J 36/02; H05B 6/12; C22C 21/00

(57) ABSTRACT

A film made of an alloy of aluminum and iron, having thickness comprised between 5 μm and 100 μm and made of an aluminum-iron alloy, comprises an aluminum amount comprised between 97% and 99% by weight with respect to the total weight of the alloy and an iron amount comprised between 1% and 2%, preferably between 1% and 1.5%. Advantageously the alloy also comprises titanium and/or boron. A pot for induction cooking, provided with a bottom (12) and with a side wall (13) defining an inner compartment (14), has at least its bottom (12) covered with a film (10) made of said aluminum-iron alloy.

The disclosure of Italian Patent Application No. MI2014A 000801 is incorporated herein by reference.

### TECHNICAL FIELD

The present invention refers to an innovative material, based on aluminum-iron alloy, capable of being quickly heated when subjected to an oscillating magnetic field and thus effectively usable for obtaining, for example, pots or other kitchen utensils adapted for cooking on induction stoves.

### BACKGROUND

As well known, induction stoves are essentially constituted by a coil (hidden beneath the cooking surface) within which an oscillating electric current is made to flow; such current produces a magnetic field, which is also oscillatable as a function of the current that generates it.

According to Faraday's law, the variations of the magnetic field flow over time produce an induced electromotive force. If a conductive metal object (e.g. a pot) comes to be situated within such oscillating magnetic field, the aforesaid induced electromotive force in turn generates induced currents (or eddy currents) that circulate inside the conductive metallic material. Due to the Joule effect, these induced currents dissipate energy in the form of heat, causing the heating of the metallic material that constitutes the pot.

In induction stoves, this is obtained by positioning the coils and adjusting the magnetic field in a manner such that the latter is extended above the cooking surface, affecting the area within which the pot is resting on the surface itself.

Of course, not all metallic materials are suitable for production of pots adapted to correctly work with the induction stoves. Indeed, it is necessary for the material to have a sufficiently low electrical resistance so to be a good conductor for the induced currents—but not too low, otherwise there would not be sufficient energy dissipation for heating the pot by Joule effect.

In the prior art, pots for induction cooking are therefore commonly used, which are made of steel or cast iron, generically made of materials of ferromagnetic type, which optimally satisfy the abovementioned requirements.

On the other hand, the kitchen utensil market often requires pots made of aluminum due to the advantages that this material brings, both in terms of lightness and in terms of thermal conductivity which is quite higher with respect to conventional steel pots.

Nevertheless, aluminum is a material which, because of its too low electrical resistance, is not adapted to generate a satisfactory quantity of heat by Joule effect if crossed by the eddy currents caused by the magnetic field of the coils; hence it is not normally usable with the induction stoves.

In order to overcome this problem, a commonly employed solution is that of manufacturing aluminum pots with the bottom constituted by a double layer: a first layer (made of aluminum) represented by the normal bottom of the pot and a second layer of steel coupled (generally by means of very high pressure values) to the first layer, below it. One example of this pot type is described in the application WO 2011/064455 A1, where the pot also has the bottom externally covered by an aluminum film in order to protect the ferromagnetic material layer.

In this manner, the pot, once placed on the induction cooking surface, is recognized by the system as a pot made of ferromagnetic material, thereby activating the electric circuit of the coils positioned below the cooking surface and consequently generating the magnetic field.

The induced currents thus generated heat the steel layer, which transmits heat by conduction to the rest of the aluminum pot.

This solution, while valid from the standpoint of operation effectiveness, has a certain complexity with regard to the manufacturing of the pot and, consequently, a rather high cost.

Another type of kitchen utensils that normally cannot be used for induction cooking are pans and other containers made of glass or ceramic, since these are electrically insulating materials.

The general object of the present invention is to overcome the abovementioned drawbacks by providing a film made of an alloy of aluminum and iron, which can be heated by induction when used in combination with an oscillating magnetic field, in particular for manufacturing of pots and kitchen utensils suitable for cooking on induction stoves.

### SUMMARY

In light of such object, it was thought to devise, according to the invention, a film made of an alloy of aluminum and iron, having a thickness comprised between 5 μm and 100 μm and made of an aluminum-iron alloy, comprising an aluminum amount comprised between 97% and 99% by weight with respect to the total weight of the alloy and an iron amount comprised between 1% and 2%.

According to the invention, it was also thought to devise a pot for induction cooking, provided with a bottom and with a side wall defining an inner compartment, characterized in that at least its bottom is covered by said film made of aluminum-iron alloy.

Still according to the invention, it was thought to use said film made of an aluminum-iron alloy in combination with an oscillating magnetic field for generating induced currents inside the film, which are adapted to cause a heating of the film itself by Joule-effect.

### BRIEF DESCRIPTION OF THE DRAWINGS

In order to clarify the explanation of the innovative principles of the present invention and its advantages with respect to the prior art, a possible embodiment applying such principles will be described hereinbelow, with the aid of the enclosed drawings. In the drawings:

FIG. 1 represents a schematic and partial view of a film according to the invention.

FIG. 2 represents a general view of a pot to which the film according to the invention is applied.

FIG. 3 represents a section view of the pot of FIG. 2.

### DETAILED DESCRIPTION

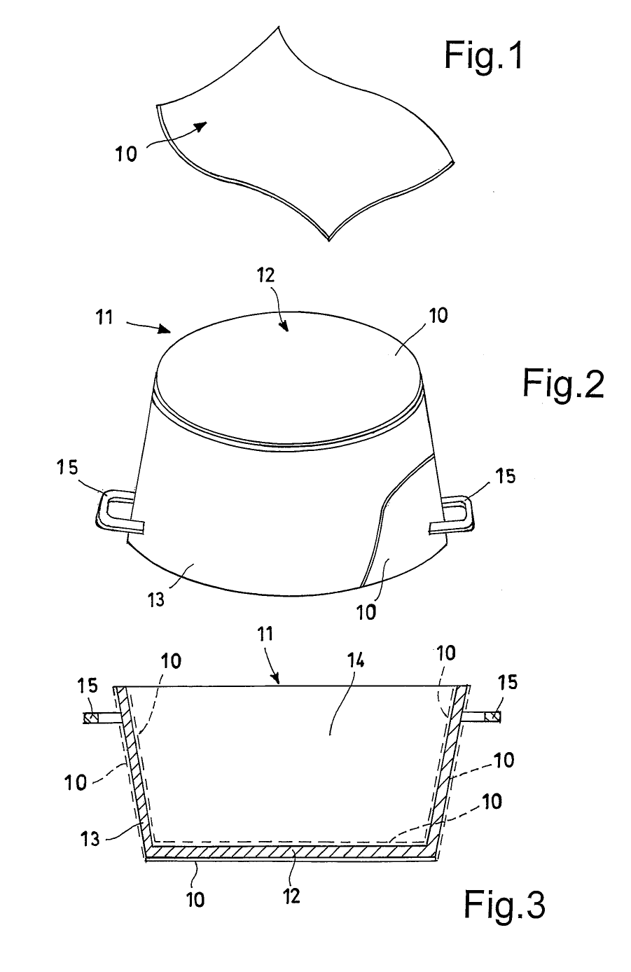

With reference to the figures, in FIG. 1, a portion of a film 10 made of an alloy of aluminum and iron according to the invention is schematically illustrated.

For graphical reasons, in the figures the thickness of the film 10 was intentionally represented (for illustration purposes) much larger than actual thickness and not proportionate with respect to the other dimensions of the pot: indeed, as will be seen hereinbelow, the thickness of the film 10 is of micron magnitude and its actual representation would not be perceptible in the drawings.

The film according to the invention is made of an alloy of aluminum and iron, with aluminum present in an amount between 97% and 99% by weight with respect to the total weight of the alloy and iron present in an amount comprised between 1% and 2%, advantageously between 1% and 1.5%.

The alloy can also comprise titanium and/or boron, each in an amount not greater than 0.5%, advantageously comprised between 0.1% and 0.2%. These metals have the purpose of achieving a satisfactory refining of the alloy, enabling formation of smaller grains of substantially spherical form and improving the overall mechanical characteristics thereof.

Traces of other (metallic and non-metallic) elements can also be present, generally in an overall amount less than 0.1%.

The film made of an aluminum-iron alloy according to the invention has a thickness comprised between 5 μm and 100 μm, preferably between 5 μm and 10 μm, and is advantageously obtained by rolling, according to processes well-known to the person skilled in metallurgy.

Indeed, it has been surprisingly found that a film made of an aluminum-iron alloy with the composition indicated herein and a thickness less than 100 μm, if arranged within an oscillating magnetic field with suitable intensity, is capable of being heated (due to the induced currents generated therein) even several hundreds degrees in a few seconds.

Therefore, by suitably adjusting the power and intensity of the magnetic field, the film according to the invention can quickly reach the desired temperature value.

Illustrated in FIG. 2 is a pot 11 provided with a bottom 12 and with a side wall 13 defining an inner compartment 14 adapted to contain liquid or solid substances intended to be heated. Advantageously, at the side wall 13, handles 15 can be present for user's grip. The handles 15 can be made of material that is not thermally conductive or with suitable thermal insulation from the body of the pot, as is well known to the person skilled in the art.

The pot advantageously has a flat bottom in order to provide optimal resting against the induction cooking surface.

The pot 11 can be made of any material suitable for heating and/or cooking of alimentary substances, foods or beverages, e.g. copper, ceramic, glass, etc., as well as of plastic materials capable of tolerating temperatures on the order of 180-200° C. without being damaged and without releasing toxic substances.

According to the invention, at least the bottom 12 of the pot is coated by the film 10 made of an aluminum-iron alloy having the above-described characteristics.

When the magnetic field of an induction stove is activated, the currents induced within the film 10 heat the latter and this in turn transmits the heat to the material that constitutes the bottom 12 and the walls 13 of the pot.

In FIG. 2, it is schematically illustrated (with a partial representation) how the film 10 can also be provided as a coating of the side wall 13 of the pot.

The film 10 can advantageously be applied to the bottom and to the walls of the pot by means of glues or resins capable of tolerating operating temperatures between 180 and 200° C.

As shown in FIG. 3 (with dashed line representation), the film 10 made of an aluminum-iron alloy according to the invention can be provided only at the external surface of the bottom 12 (and possibly at the side wall 13) or also (or only) at the internal surfaces.

The solution with external coating in any case represents the optimal solution because it avoids a possible damage of the film itself, which could occur (if present inside) if the content of the pot requires mixing or blending with spoons, forks etc., and because it allows the interior of the pot, which is in direct contact with the food to be heated or cooked, to be maintained in the material (copper, ceramic, glass, etc.) most suitable for the specific use.

A film made of an alloy of aluminum and iron according to the invention, applied to a pot made of copper, ceramic, glass, etc., assures the pot itself of ferromagnetic and electrical conductivity characteristics that render it suitable for operation with induction stoves, while maintaining all the peculiar characteristics of the materials that constitute the body of the pot.

At this point it is clear that, with a film made of an alloy of aluminum and iron according to the invention, and a pot at least partially coated with such film, the proposed objects are attained.

Naturally, the above-made description of an embodiment applying the innovative principles of the present invention is reported as an example of such innovative principles and must not therefore be taken as a limitation of the scope of the patent claimed herein.

In particular, the use of a film made of an alloy of aluminum and iron according to the invention, in combination with an oscillating magnetic field for generating induced currents inside the film itself, can also be applied in contexts outside the kitchen, e.g. if it is desired to achieve generic heating surfaces or elements.

Still within the field of pots, another possible use of a film made of an alloy of aluminum and iron according to the invention could consist of obtaining a separate bottom element, with diameter that can vary as a function of the size of the pots for which it is intended, constituted by a pair of discs made of non-ferromagnetic material (e.g. made of ceramic, glass or plastic), enclosing like a sandwich a film made of an aluminum-iron alloy according to the invention.

This element could be used in a simple and versatile manner by simply leaning it against the bottom of any already-existing pot, when it must be used with an induction stove. With this solution, it has been found that a pot full of water can be quickly brought to boiling temperature with an energy savings even greater than 30% with respect to conventional pots.

1. Film made of an alloy of aluminum and iron, having a thickness comprised between 5 μm and 100 μm and made of an aluminum-iron alloy comprising an aluminum amount comprised between 97% and 99% by weight with respect to the total weight of the alloy and an iron amount comprised between 1% and 2%.

2. Film according to claim 1, characterized in that it has a thickness comprised between 5 μm and 10 μm.

3. Film according to claim 1, characterized in that iron is present in an amount comprised between 1% and 1.5%.

4. Film according to claim 1, characterized in that the alloy of aluminum and iron also contains titanium and/or boron.

5. Film according to claim 4, characterized in that the content of titanium in the alloy is not greater than 0.5% by weight to the total, preferably comprised between 0.1% and 0.2%.

6. Film according to claim 4, characterized in that the content of boron in the alloy is not greater than 0.5% by weight to the total, preferably comprised between 0.1% and 0.2%.

7. Pot for induction cooking, provided with a bottom (12) and with a side wall (13) defining an inner compartment (14), characterized in that at least its bottom (12) is covered by a film (10) made of an alloy of aluminum and iron according to claim 1.

8. Pot for induction cooking according to claim 7, characterized in that the film (10) also covers the side wall (13) of the pot.

9. Pot for induction cooking according to claim 7, characterized in that the film (10) covers the pot externally.

10. Pot for induction cooking according to claim 7, characterized in that the film (10) is applied to the pot by means of glues or resins capable of tolerating operating temperatures between 180 and 200° C.

11. Pot for induction cooking according to claim 7, characterized in that the body of the pot is made of a material selected among copper, ceramic, glass or plastic materials.

12. Use of a film (10) made of an alloy of aluminum and iron according to claim 1, in combination with an oscillating magnetic field for generating induced currents inside the film, which are adapted to cause a heating of the film itself by Joule-effect.

13. Use of a film made of an alloy of aluminum and iron in combination with an oscillating magnetic field according to claim 12, wherein a discoid element, constituted by a pair of discs made of non-ferromagnetic material that enclose said film made of an alloy of aluminum and iron like a sandwich, is inserted inside a pot and leant against its bottom in order to constitute a heating element when it is situated inside an oscillating magnetic field.
